(19) United States
(12) Patent Application Publication
(10) Pub. No.: US 2026/0171689 A1
(43) Pub. Date: Jun. 18, 2026

(54) BUS BAR STRUCTURE AND BUS BAR

(71) Applicant: YAZAKI CORPORATION, Tokyo (JP)

(72) Inventor: Kazuki Shirosaka, Kakegawa-shi (JP)

(21) Appl. No.: 19/408,357

(22) Filed: Dec. 4, 2025

(30) Foreign Application Priority Data
Dec. 18, 2024 (JP) 2024-222360

(51) Int. Cl. H01R 4/58; H01R 4/02; H02G 5/02

(52) U.S. Cl. CPC H01R 4/58; H01R 4/029; H02G 5/02

(57) ABSTRACT

A bus bar structure includes a first bus bar and a second bus bar that are abutted against each other and joined in a width direction or a length direction. The first bus bar includes a first bus bar body and a first thin end portion provided to be thinner than the first bus bar body. The first thin end portion is curved in a thickness direction. The first thin end portion of the first bus bar and an end portion of the second bus bar are abutted against each other and joined.

### CROSS-REFERENCE TO RELATED APPLICATION(S)

This application is based upon and claims the benefit of priority from prior Japanese patent application No. 2024-222360 filed on Dec. 18, 2024, the entire contents of which are incorporated herein by reference.

### BACKGROUND

### 1. Field of the Invention

The present disclosure relates to a bus bar structure and a bus bar.

### 2. Description of the Related Art

In the related art, in a vehicle on which an internal combustion engine or an electric motor is mounted, a bus bar structure in which a plurality of strip-shaped bus bars are connected is used (for example, see JP2023-23721A). In the bus bar structure in JP2023-23721A, the plurality of bus bars are joined to form a three-dimensional routing path.

When end surfaces of a pair of bus bars are joined to each other, the end surfaces may not face each other due to deformation, a dimensional error, or the like of the bus bar. In this case, a jig is used for each bus bar to correct the deformation and the dimensional error, so that the end surfaces of the bus bars face each other and joined by welding or the like to form a bus bar structure. However, such a method has a problem that a manufacturing cost of a bus bar structure increases due to the necessity of installing a jig and the necessity of labor of an operator.

The present disclosure has been made in view of the circumstances described above, and an object of the present disclosure is to provide a bus bar structure and a bus bar capable of reducing a manufacturing cost even when deformation or a dimensional error occurs in the bus bar.

### SUMMARY

In order to achieve the object described above, according to an aspect of the present disclosure, there is provided a bus bar structure including a first bus bar and a second bus bar that are abutted against each other and joined in a width direction or a length direction, in which: the first bus bar includes a first bus bar body and a first thin end portion provided to be thinner than the first bus bar body; the first thin end portion is curved in a thickness direction; and the first thin end portion of the first bus bar and an end portion of the second bus bar are abutted against each other and joined.

In order to achieve the object described above, according to another aspect of the present disclosure, there is provided a bus bar including a bus bar body and a thin end portion provided to be thinner than the bus bar body, in which the thin end portion is curved in a thickness direction.

According to the bus bar structure according to the present disclosure, a manufacturing cost can be reduced even when deformation or a dimensional error occurs in the bus bar.

According to the bus bar according to the present disclosure, the manufacturing cost can be reduced even when deformation or a dimensional error occurs in the bus bar.

The present disclosure has been briefly described above. Details of the present disclosure can be clarified by reading modes (hereinafter, referred to as “embodiments”) for carrying out the invention to be described below with reference to the attached drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a side view illustrating a bus bar structure and bus bars according to an embodiment of the present disclosure, and is a schematic plan view;

FIG. 2 is a side view illustrating a state in which a dimensional tolerance along a length direction occurs between the bus bars; and

FIG. 3 is a side view illustrating a state in which a dimensional tolerance along a thickness direction occurs between the bus bars.

### DETAILED DESCRIPTION OF THE INVENTION

### Embodiment

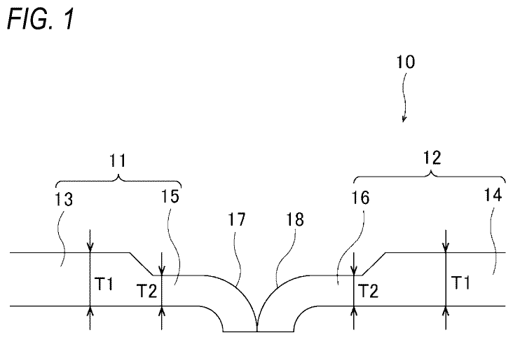

Hereinafter, a bus bar structure and bus bars according to an embodiment of the present disclosure will be described with reference to the drawings. As illustrated in FIG. 1, a bus bar structure 10 according to the embodiment of the present disclosure includes two bus bars 11 (first bus bar) and 12 (second bus bar) that are abutted against each other and joined in a width direction or a length direction.

The bus bar 11 includes a bus bar body 13 (first bus bar body) and a thin end portion 15 (first thin end portion). The bus bar 12 includes a bus bar body 14 (second bus bar body) and a thin end portion 16 (second thin end portion). Each of the bus bar body 13 and the bus bar body 14 is formed in a substantially strip shape having a predetermined thickness. The thin end portion 15 and the thin end portion 16 are respectively provided at end portions in a longitudinal direction of respective bus bar bodies 13 and 14. Each of the thin end portions 15 and 16 is provided to have a thickness smaller than a thickness dimension T1 of respective bus bar bodies 13 and 14 or is a thickness dimension T2 that is half of the thickness dimension T1.

The thin end portions 15 and 16 are curved in a thickness direction such that convex arc surfaces 17 and 18 respectively face directions away from the bus bar bodies 13 and 14. In such a bus bar structure 10, the thin end portions 15 and 16 are abutted against each other and the bus bars 11 and 12 are in contact with each other such that generatrices of the arc surfaces 17 and 18 are in line contact with each other. In this state, contact portions of the arc surfaces 17 and 18 are joined by welding or the like to obtain the bus bar structure 10.

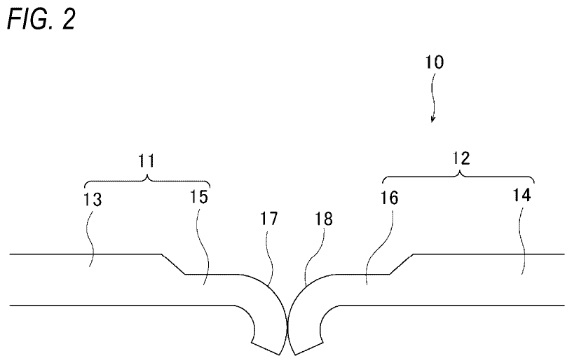

As illustrated in FIG. 2, in the bus bar structure 10, when the bus bars 11 and 12 have a dimensional tolerance along the length direction, by further curving and deforming the thin end portions 15 and 16, the dimensional tolerance is corrected while maintaining the state in which the generatrices of the arc surfaces 17 and 18 are in line contact with each other.

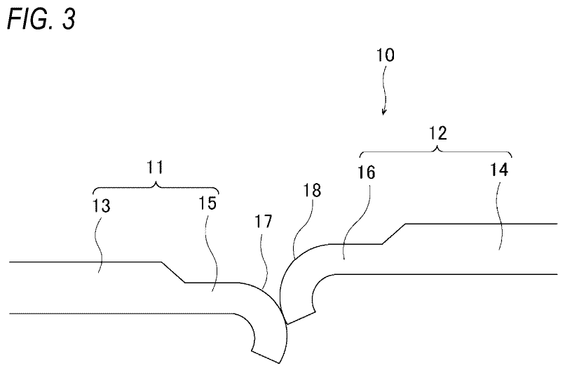

As illustrated in FIG. 3, in the bus bar structure 10, when one or both of the bus bars 11 and 12 have a dimensional tolerance along the thickness direction, by changing a portion in line contact, the dimensional tolerance is corrected while maintaining the state in which the generatrices of the arc surfaces 17 and 18 are in line contact with each other.

### Effects of Embodiment

As described above, according to the bus bar structure 10 according to the embodiment in the present disclosure, in the two bus bars 11 and 12, the thin end portions 15 and 16 curved in the thickness direction are abutted against each other and joined. Therefore, even when the deformation, the dimensional error, or the like occurs in each of the bus bars 11 and 12, a jig as in the related art is not required, and labor of an operator is not required, so that a problem that a manufacturing cost of the bus bar structure increases does not occur.

In the bus bar structure 10 according to the embodiment in the present disclosure, the thickness dimension T2 of each of the thin end portions 15 and 16 of the two bus bars 11 and 12 is half of the thickness dimension T1 of each of the bus bar bodies 13 and 14. Therefore, the thin end portions 15 and 16 can be easily curved, and even when the bus bars 11 and 12 have the dimensional tolerance along the length direction, the dimensional tolerance can be corrected by further curving and deforming the thin end portions 15 and 16, thereby improving manufacturing efficiency of the bus bar structure 10.

The bus bar 11 according to the embodiment in the present disclosure includes the bus bar body 13 and the thin end portion 15 that is provided to be thinner than the bus bar body 13. The bus bar 12 according to the embodiment in the present disclosure includes the bus bar body 14 and the thin end portion 16 that is provided to be thinner than the bus bar body 14. The thin end portions 15 and 16 are curved in the thickness direction. Therefore, even when the deformation, the dimensional error, or the like occurs in each of the bus bars 11 and 12, a jig as in the related art is not required, and labor of an operator is not required, so that a problem that the manufacturing cost of the bus bar structure 10 increases does not occur.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of the components in the embodiment described above are freely selected and are not limited as long as the present disclosure can be implemented.

For example, in the embodiment described above, the thin end portions 15 and 16 are respectively provided in the bus bars 11 and 12, but the thin end portion 15 and 16 may be provided in only one of the bus bars 11 and 12, and such a form is also included in the present disclosure. In the embodiment described above, the thin end portions 15 and 16 of the bus bars 11 and 12 are formed in a symmetrical shape with respect to a joint portion, but curved directions of the thin end portions 15 and 16 may be reversed as long as the generatrices of the arc surfaces 17 and 18 are in line contact with each other.

Here, features of the bus bar structure and the bus bar according to the embodiment in the present disclosure described above are briefly summarized and listed in the following [1] to [14].
[1] A bus bar structure (10) including a first bus bar (11) and a second bus bar (12) that are abutted against each other and joined in a width direction or a length direction, in which
the first bus bar (11) includes a first bus bar body (13) and a first thin end portion (15) provided to be thinner than the first bus bar body (13),
the first thin end portion (15) is curved in a thickness direction, and
the first thin end portion (15) of the first bus bar (11) and an end portion of the second bus bar (12) are abutted against each other and joined.

According to the bus bar structure (10) having the configuration of the above [1], the first thin end portion (15) of the first bus bar (11) and the end portion of the second bus bar (12) are abutted against each other and joined. Therefore, even when deformation, a dimensional error, or the like occurs in each of the first and second bus bars (11 and 12), a jig as in the related art is not required, and labor of an operator is not required, so that a problem that a manufacturing cost of the bus bar structure increases does not occur.
[2] The bus bar structure (10) according to [1], in which
the second bus bar (12) includes a second bus bar body (14) and a second thin end portion (16) provided to be thinner than the second bus bar body (14),
the second thin end portion (16) is curved in the thickness direction, and
the first thin end portion (15) of the first bus bar (11) and the second thin end portion (16) of the second bus bar (12) are abutted against each other and joined.

According to the bus bar structure (10) having the configuration of the above [2], in the two first and second bus bars (11 and 12), the first and second thin end portions (15 and 16) curved in the thickness direction are abutted against each other and joined. Therefore, even when deformation, a dimensional error, or the like occurs in each of the first and second bus bars (11 and 12), a jig as in the related art is not required, and labor of an operator is not required, so that a problem that a manufacturing cost of the bus bar structure increases does not occur.
[3] The bus bar structure (10) according to [2], in which
the first thin end portion (15) is provided to have a thickness that is half of a thickness of the first bus bar body (13), and
the second thin end portion (16) is provided to have a thickness that is half of a thickness of the second bus bar body (14).

According to the bus bar structure (10) according to the above [3], a thickness dimension (T2) of each of the first and second thin end portions (15 and 16) of the two first and second bus bars (11 and 12) is half of a thickness dimension (T1) of each the first and second bus bar bodies (13 and 14). Therefore, the first and second thin end portions (15 and 16) can be easily curved, and even when the first and second bus bars (11 and 12) have a dimensional tolerance along the length direction, the dimensional tolerance can be corrected by further curving and deforming the first and second thin end portions (15 and 16), thereby improving manufacturing efficiency of the bus bar structure (10).
[4] A bus bar (11, 12) including a bus bar body (13, 14) and a thin end portion (15, 16) provided to be thinner than the bus bar body (13, 14), in which
the thin end portion (15, 16) is curved in a thickness direction.

According to the bus bar (11, 12) having the configuration of the above [4], since the bus bar (11, 12) includes the bus bar body (13, 14) and the thin end portion (15, 16) provided to be thinner than the bus bar body (13, 14), and the thin end portion (15, 16) is curved in the thickness direction, even when deformation, dimensional error, or the like occurs in the bus bar (11, 12), a jig as in the related art is not required, and labor of an operator is not required, so that a problem that a manufacturing cost of the bus bar structure (10) increases does not occur.

1. A bus bar structure comprising
a first bus bar and a second bus bar that are abutted against each other and joined in a width direction or a length direction, wherein:
the first bus bar includes a first bus bar body and a first thin end portion provided to be thinner than the first bus bar body;
the first thin end portion is curved in a thickness direction; and
the first thin end portion of the first bus bar and an end portion of the second bus bar are abutted against each other and joined.

2. The bus bar structure according to claim 1, wherein:
the second bus bar includes a second bus bar body and a second thin end portion provided to be thinner than the second bus bar body;
the second thin end portion is curved in the thickness direction; and
the first thin end portion of the first bus bar and the second thin end portion of the second bus bar are abutted against each other and joined.

3. The bus bar structure according to claim 2, wherein:
the first thin end portion is provided to have a thickness that is half of a thickness of the first bus bar body; and
the second thin end portion is provided to have a thickness that is half of a thickness of the second bus bar body.

4. A bus bar comprising:
a bus bar body; and
a thin end portion provided to be thinner than the bus bar body, wherein
the thin end portion is curved in a thickness direction.
